(19) United States
(12) Patent Application Publication
(10) Pub. No.: US 2003/0182710 A1
(43) Pub. Date: Oct. 2, 2003

(54) Protective garment

(76) Inventors: Conrad Lee Klotz, Nappanee, IN (US); Christian H. Clupper, Columbia City, IN (US)

Correspondence Address: Paul J. Maginot, Maginot, Addison & Moore, Bank One Center/Tower, 111 Monument Circle, Suite 3000, Indianapolis, IN, 46204-5115, US

(21) Appl. No.: 10/106,578

(22) Filed: Mar. 26, 2002

(51) Int. Cl. A42C 5/04; A62B 17/00

(52) U.S. Cl. 2/171.3; 2/457; 2/DIG. 3

(57) ABSTRACT

A protective garment includes a gown adapted to be worn on the torso of a person and a head cover sealingly attached to the gown. The head cover is defined by a film formed of an elastic, air impermeable, optically clear material that is configured to inflate when the airspace within the head cover is above atmospheric pressure. In a preferred embodiment, the head cover inflates to a substantially spherical shape around the head of the wearer. The inflated head cover provides an airspace sufficiently large to accommodate any air-moving system associated with the protective garment. The head cover can include a filter mounted within an opening in the film, and can be provided with features for attaching the filter to a fan assembly of a helmet-mounted ventilation system.

### BACKGROUND OF THE INVENTION

The present invention relates generally to protective garments, and particularly garments that provide a generally sealed air space around the head of the wearer. The invention has particular application as a surgical garment adapted for use by operating room personnel and incorporating a personal portable ventilation system.

Surgical gowns have long been used to cover and protect a surgeon and associated medical personnel in an operating room. The typical surgical gown is formed from non-woven fabrics and is generally in the nature of an overcoat protecting or covering the medical personnel from the neck down. In order to help maintain a sterile environment, the medical personnel also wear a breathing mask over the mouth and nose. The breathing mask is constructed in a manner to filter inhaled and exhaled air from the medical personnel.

As the art of surgery has developed, the need to protect the patient by maintaining a sterile environment in the operating room has increased. In addition, a new demand has arisen for protecting the medical personnel. One specific motivation for this need has been the advent of diseases, such as AIDS, which can be communicated by exposure to bodily fluids. Accordingly, surgical gowns have been developed that include head sections that cover the face and head of the medical personnel. Now, the operating room attendants are covered virtually from head to foot, which helps to reduce the risk of contamination of the surgical environment and patient, as well as contamination of the medical personnel.

Of course, once the head of the medical personnel is covered, ventilation becomes an issue. A variety of personal air supply and filtration systems have been devised for use with protective garments, such as surgical gowns. In some instances, a mouthpiece and air supply, akin to an underwater diving apparatus, have been implemented. In other systems, a helmet or headpiece is worn by the medical personnel in which the helmet carries the ventilation components. In one typical installation, the ventilation component is a fan and a series of ducts that direct airflow to the mouth and nose of the medical personnel.

While the ventilation and air supply problems associated with covering of the head of the medical personnel have been addressed, some difficulty still remains with respect to visibility. More particularly, it is not surprising that visibility from within a total head and body-covering garment can be limited and often distorted. In some prior surgical gowns or protect garments, the helmet supports a viewing window. These viewing windows have assumed a variety of shapes and sizes. In some garments, the window is in the form of a semicircular or partially cylindrical transparent wall that must be supported on the shoulders of the wearer. In other devices, the helmet supports a small window, usually rectangular or oblong in shape.

Most viewing windows are formed of a plastic material, which helps to reduce the weight of the components that must be carried on the head of the wearer. However, these viewing windows are highly susceptible to distortion as light is reflected and refracted by various curvatures in the viewing window. In order to address these distortion issues, smaller generally flat windows have been provided, but these windows have their own problems in that the viewing area is significantly limited.

Many viewing windows are produced by injection molding, which can be expensive and can result in a heavier part. Moreover, variability in the molding process can produce flaws in the window, which manifest themselves as distortion in the viewing area. Finally, all of the prior viewing windows still retain some bulkiness which can make movement somewhat cumbersome and fatiguing over a lengthy surgery.

While protective garments and body-covering surgical gowns have improved greatly over the last decade, there is still significant room for improvement of the viewing feature of these garments. More specifically, there is a need for a viewing capability that provides an undistorted wide viewing field for the medical personnel. In addition, there is a need for a viewing capability that is not unwieldy or cumbersome to wear and use.

### SUMMARY OF INVENTION

In order to address these needs, the present invention contemplates a protective garment comprising a gown configured to cover at least a portion of the torso of the wearer and a head cover attached to the gown. The head cover defines an airspace around the head of the wearer, and has at least a portion formed of an elastic, optically clear material configured to assume an inflated shape when the airspace is pressurized. In a preferred embodiment, the head cover assumes the shape of an inflated spherical bubble that surrounds the head of the wearer. The inflated head cover is sized to also accommodate an air moving system disposed within the airspace, such as a helmet-mounted ventilation apparatus.

The inflatable head cover defines a neck opening that is preferably sealing attached to a gown configured to cover the torso of the wearer. The neck opening provides an air flow path for pressurized air within the head cover. Most preferably, the ventilation apparatus is disposed at the top of the wearer's head to direct air downward over the wearer's head and out the neck opening.

In one aspect of the preferred embodiment, the head cover defines an air permeable opening to provide an air flow path between the ventilation apparatus and air outside the head cover. Most preferably, a filter is disposed within the opening to filter outside air as it is drawn into the head cover.

The ventilation apparatus can include a fan mounted on a helmet. The air inlet of the fan can be oriented so that it is in direct communication with the opening in the head cover. Means can be provided for attaching the filter mounted within the opening to the fan to maintain the fan inlet in air-tight communication with the opening and filter.

In one feature of the invention, the head cover is formed of a film of an elastic, optically clear, air-impermeable material. When the head cover is inflated, any creases or wrinkles in the film are smoothed out so that the inflated head cover presents an undistorted viewing area for the wearer. The air-impermeability allows the head cover to retain its inflated shape when the air pressure within the airspace is above atmospheric. In certain specific embodiments, portions of the head cover can be air-permeable, to provide venting for the head cover. However, in accordance with the most preferred embodiment, air within the inflated head cover is vented through the neck opening and down through the gown.

In one aspect of the invention, the entire head cover film is composed of the optically clear, inflatable material. With this embodiment, the inflated head cover presents an uninterrupted, undistorted 360° viewing area. In some protective garments, the head cover is remote from the head of the wearer, so the wearer can rotate his/her head fully within the head cover. In other instances, the head cover may be associated with a helmet worn by the person, so that head movement is kept to a minimum. In these instances, only a portion of the inflated head cover need provide an optically clear film. The remainder of the head cover film may be optically translucent or even opaque, and may include a coating to reduce the transparency of this remainder portion.

In another aspect of the invention, a hood is provided for use as part of a ventilated garment. The hood is defined by a film formed of an elastic material that is configured to assume an inflated shape about the head of the wearer when pressurized. At least a portion of film is optically clear to provide an undistorted viewing area for the wearer. In a most preferred embodiment, the entire hood is optically clear. In alternative embodiments, only a portion of the hood disposed at the face of the wearer is optically clear.

In one feature of the invention, the hood film is substantially air impermeable. The hood film can define an air permeable opening that is optimally configured to support a filter element mounted therein. The filter element and/or the film opening can include features that permit attachment of the filter to a ventilation fan associated with an air-moving system worn by the wearer.

It is one object of the invention to provide a head cover for use as part of a protective garment. A further object is to provide a head cover that provides an undistorted comprehensive viewing area for the wearer.

One significant benefit of the present invention is that it provides an extremely lightweight head cover that eliminates the cumbersome nature head covers. A further benefit is accomplished by features of the invention that permit a substantially undistorted expanded viewing area from prior systems. These and other objects and benefits can be discerned from the following written description taken with the accompanying figures.

### DESCRIPTION OF THE FIGURES

FIG. 1 is a side elevational view of one type of body-covering protective garment that can be used in combination with the present invention.

FIG. 2 is a side partial cross sectional view of the head cover portion of the garment shown in FIG. 1, particularly illustrating one type of ventilation apparatus that can be used with the present invention.

FIG. 3 is a side view of a head covering in accordance with one embodiment of the present invention, and shown in use with the ventilation system and garments shown in FIGS. 1 and 2.

FIG. 4 is a top elevational view of the head covering shown in FIG. 3 particularly focusing on a filter element within the covering.

FIG. 5 is a side cross sectional view of the head covering shown in FIG. 4 taken along line 5-5 as viewed in the direction of the arrows.

FIG. 6 is a side elevational view of the head covering shown in FIG. 3 prior to being worn by a person.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

The present invention contemplates a protective garment that includes head covering or hood made of an elastic expandable material. In particular, the invention contemplates an inflatable hood defined by a film formed of a transparent material, such as a plastic. The inflatable hood is sized to fit over not only the head of the wearer, but also any associated ventilation apparatus. Operation of the ventilation apparatus produces an above atmospheric pressure within the interior of the inflatable hood, thereby causing the hood to inflate. In the most preferred embodiment, the hood inflates to a substantially spherically shape and is maintained under sufficient pressure to eliminate any wrinkles or creases that may have formed in the material so that the inflated hood, or bubble, ultimately present a smooth, undistorted wide angle viewing area.

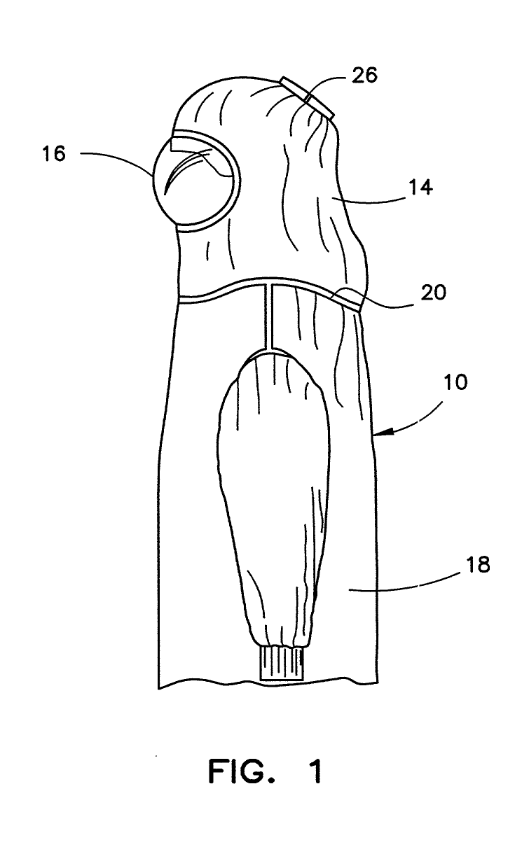

The inflatable hood of the present invention is configured for use with a surgical gown or protective garment, such as the garment 10 illustrated in FIG. 1. This garment 10 includes a fabric hood 14 that fits over the head of the wearer. The hood includes a face shield 16 to provide a viewing area for the medical personnel. The garment also includes a gown portion 18 that covers at least a portion of the torso of the wearer, and preferably the entirety of the person's body except the head. The fabric hood 14 can be attached to the gown 18 at a seam 20 to cover the wearer's head.

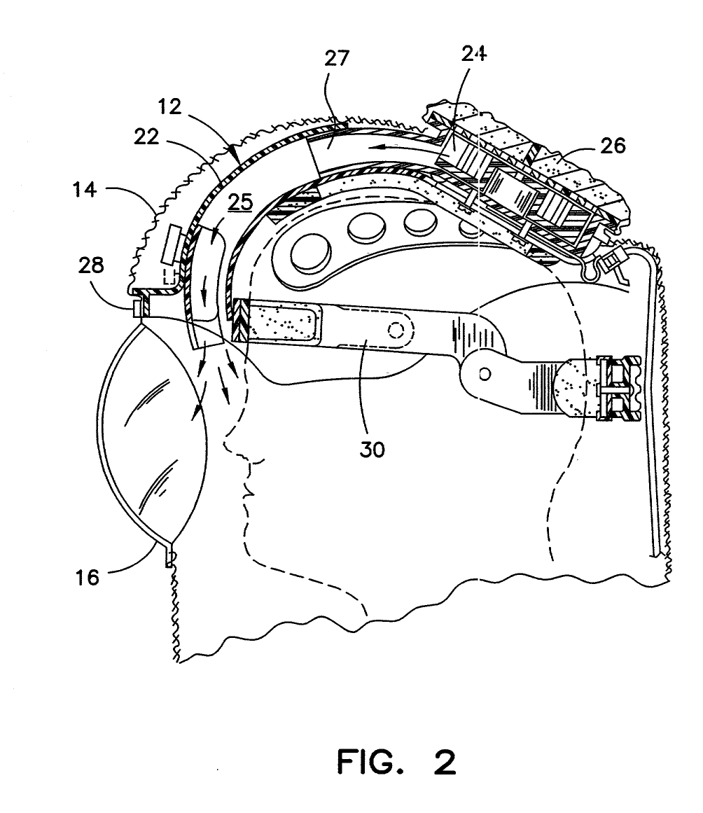

The protective garment 10 shown in FIG. 1 also includes an air moving apparatus in the form of a ventilation helmet 12, as depicted generally in FIG. 2. The helmet 12 includes a shell 22 that is preferably formed of a plastic material and that is configured to be worn on the head of the person. The shell carries a fan assembly 24 that draws exterior air through a filter 26 into the interior of the hood 14. In the ventilation helmet 12 depicted in FIG. 2, the fan assembly 24 directs air through an airflow channel 25 across the face of the wearer to provide breathable air and to help eliminate any fogging of the viewing window or face shield 16.

As shown in FIG. 2, the face shield 16 is carried by the helmet 12 by way of a face shield support 28. A strap assembly 30 helps maintain the helmet in position on the head of the wearer and helps the wearer account for the weight and inertia of the components of the helmet.

In this garment 10, the filter 26 is supported by the fan assembly 24. The fabric hood 14 is configured to sealing engage the fan assembly and/or filter 26. The orientation of the fan assembly 24 relative to the head of the wearer can be adjusted by an adjustable conduit 27 that slides to variable positions within the airflow channel 25. Thus, the fan 24 can be shifted to a position that is comfortable to the wearer.

The protective garment 10 and the ventilation helmet 12 described with respect to FIGS. 1 and 2 are the subject of a co-pending PCT application International Publication No. WO 99/35927, filed on Jan. 15, 1999 and based on U.S. Provisional application Ser. No. 60/071,753, filed on Jan. 16, 1998. The description of the garment and the ventilation helmet in this co-pending PCT application is incorporated herein by reference. In the preferred embodiment of the present invention, the inflatable hood is adapted for use with this garment 10 and ventilation helmet 12. However, it is contemplated that the invention can be used with a variety of protective garments, garment configurations, and gowns, as well as with a wide range of ventilation systems.

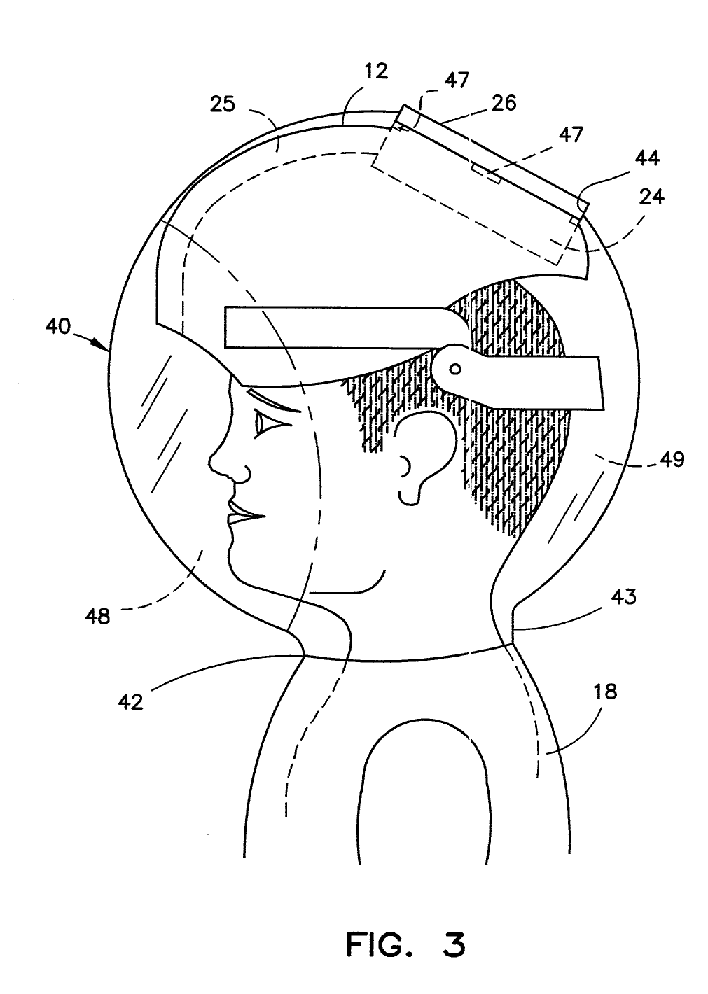

Referring now to FIG. 3, it can be seen that the present invention contemplates an inflatable hood 40 that is sized to surround the head of the wearer and to provided an ample airspace around the wearer. The hood 40 can be attached to a gown 18 at a seam 42 in a conventional manner. The inflatable hood 40 is defined by a film 41 (FIG. 5) formed of an elastic, optically clear material so that the hood takes on the form of a transparent bubble when inflated. The film material is most preferably substantially air impermeable. The film material can be a cellulosic plastic or a silicone resin, for example. The hood 40 can be produced in a manner similar to the production of inflatable balloons.

The main portion of the hood is spherical and merge into a neck portion 43. The neck portion is preferably attached to the gown 18 to form an air-tight seal between the hood 40 and gown 18 so that air flow from the hood must be through the gown. This attachment can be in a variety of conventional manners. For instance, a bead of hood material can be formed around the perimeter of the neck portion 43. This bead of material can either be sewn to the gown 18 or can be elastically retained within an upper portion of the gown.

Most preferably, an airtight seal is formed at the seam 42 between the inflatable hood 40 and the gown 18. This airtight seal will help maintain an above-atmospheric air pressure within the interior of the inflatable hood 40 when the ventilation system is operating. Preferably, the film 41 of the inflatable hood 40 is formed of a material that is sufficiently elastic to assume an undeformed shape, such as the shape of 40′ shown in FIG. 6. When the hood is placed over the wearer and the ventilation system is activated, the air pressure within the hood airspace increases to inflate the hood to the generally spherical shape shown in FIG. 3. The reduce area of the neck portion 43, together with the air-tight seal to the gown 18, helps maintain the pressure within the hood.

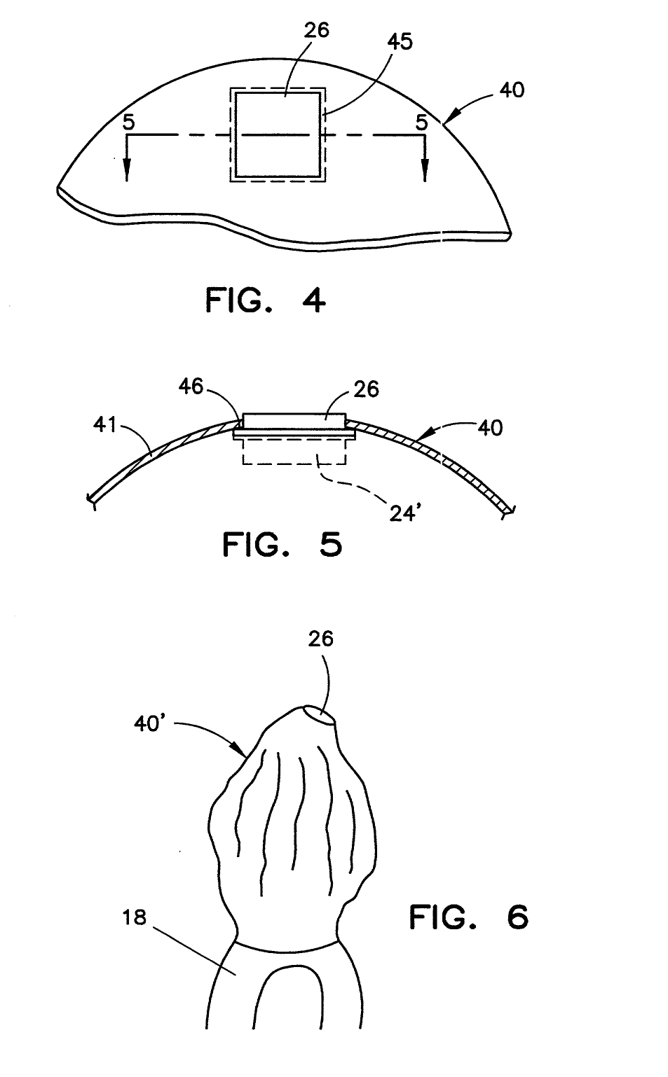

As illustrated in FIG. 3, the inflatable hood 40 is configured to integrate with a ventilation system, such as the ventilation helmet 12 shown in detail of FIG. 2. In the preferred embodiment, the inflatable hood 40 includes an air permeable opening 44 that preferably includes a filter element 26 mounted therein. As best shown in FIGS. 4 and 5, the filter element can be attached to the hood material by way of a filter seal 45. In a preferred embodiment, this seal constitutes a perimetrical flange 46 (FIG. 5) around the perimeter of the filter 26. The hood material can then be sealingly attached to the flange 46, such as by heat sealing or adhesive attachment. Again, a leak-proof seal is important to help maintain the air pressure within the inflatable hood 40. The filter 26 can be formed of any conventional material used for filtration of personal ventilation systems. Most preferably the filter 26 is formed of a lightweight material so that the hood 40 can adequately support the filter when it is inflated.

Naturally, the filter 26 is most appropriately positioned directly adjacent the inlet to the fan assembly 24. In one embodiment, the filter 26 is positioned on the hood 40 so that it becomes aligned with the fan assembly 26 when the helmet 12 and hood 40 are being worn by the person. In this instance, the fan will naturally draw air through the filter, although it might be anticipated that there may be some recirculation of the air within the interior of the hood.

In a preferred embodiment, means 46 are provided for connecting the filter 26 to the fan assembly 24. This means for connection 46 can be modified depending upon the nature of the filter 26 and the fan assembly 24. In a specific embodiment, the means for connection 47 can include a number of latches or hooks projecting from the flange 46. These hooks can engage corresponding notches (not shown) within the fan assembly 24. Alternatively, the means for connection 47 can be associated with the fan assembly 24, again assuming a variety of configurations, that all are arranged to connect the filter 26 to the fan assembly 24.

In an alternative embodiment, a fan assembly 24′ can be mounted directly to the flange 46 so that the fan assembly 24′ can be supported by the inflatable hood 40 along with the filter 26. With this embodiment, the fan assembly 24′ would necessarily be formed of a lightweight material so that it will not cause the hood 40 to deflate or to deflect significantly at the point of attachment. However, if the fan assembly 24′ is sufficiently light and if the air pressure within hood 40 is sufficiently great, the hood will be capable of supporting the fan.

As indicated above, the hood assembly 40 is preferably formed entirely of an optically clear or transparent material. Alternatively, only a portion of the inflatable hood 40 need be optically clear. For instance, a viewing area 48 can be clear or transparent, while the remainder 49 of the hood can be translucent or even opaque. The viewing area 48 can be made sufficiently large so that wearer has a full unobstructed view from within the hood 40. In embodiments where the hood 40 is not attached directly to a headpiece or helmet, such as helmet 12, the person wearing the hood may rotate his/her head within the hood. In this instance, the viewing area 48 must be sufficiently large to account for the normal range of head rotation from side-to-side.

The remaining portion 49 of the hood 40 can have adjusted optical properties to, for instance, reduce glare or stray light passing into the hood. In addition, if the inflatable hood 40 is used on a protective garment outside the surgical area, different opacities may be desirable. For example, if the garment is to be used outdoors, a reflective coating in the portion 49 may be desirable to help reduce heat buildup within the inflatable hood 40 due to incident sunlight.

In yet another alternative, the viewing area 48 can be formed of the elastic optically clear material discussed above, while the remaining portion 49 can be formed of a different material. However, it is important that the material of the remaining portion 49 be generally air-tight in order to maintain the air pressure within the hood 40. Maintaining the air pressure will maintain the expanded shape of the viewing area 48 so that the wearer will have an undistorted view. The portion 49 can even be formed of a rigid material, such as a rigid plastic. While a rigid portion 49 will not balloon, the viewing area 48 will retain its elastic properties so that the area48 becomes inflated under pressure within the hood.

The inflatable hood 40 of the present invention offers significant advantages over prior head coverings on protective garments. For instance, the hood can be formed of a thin sheet of material, such as on the order of 0.1 mm thick, or less, depending upon the material. The hood, thus, will have a negligible weight, and certainly will be so light that its presence will not be noticed by the wearer. For stability, the hood 40 may be preferably connected to a headpiece worn by the person, such as the ventilation helmet 12 described above.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

Thus, while the present invention contemplates using the inflatable hood with a helmet-mounted ventilation system, other systems for ventilating the protective garment are contemplated. For instance, the airspace within the hood can be ventilated by an air supply within the gown 18 that blows air upward into the hood. In this case, the filter 26 can be mounted at the top of the hood and can operate to filter the air discharged from the hood. As with the prior embodiment, the airflow into the hood can be calibrated to the air discharged therefrom to maintain an above atmospheric pressure within the hood.

As a further modification, additional filters may be provided at different locations on the hood. The additional filters may be advantageously positioned adjacent additional ventilation apparatus. In yet another alternative, exhaust slits or flaps may be defined in the inflatable hood to exhaust air from the hood. An exhaust flap may be provided to prevent over-pressurization and over-inflation of the inflatable hood 40, as might occur if the exit path for the airflow through the gown 18 became restricted or obstructed. The exhaust flap can operate in the manner of a check-valve or a pop-off valve to open at a pre-determined pressure.

On the other end of the spectrum, the ventilation apparatus can include means for adjusting the airflow to maintain a pre-determined optimum pressure within the inflatable hood 18. Thus, the ventilation fan may increase in speed if the pressure drops below an acceptable level, or decrease if the pressure becomes too high.

What is claimed is:

1. A protective garment comprising:
a gown configured to cover at least a portion of the torso of the wearer; and
a head cover attached to said gown and defining an airspace around the head of the wearer, said head cover having at least a portion formed of an elastic, optically clear material configured to assume an inflated shape when said airspace is pressurized.

2. The protective garment according to claim 1, further comprising an air moving apparatus operable to generate air flow through said airspace.

3. The protective garment according to claim 2, wherein said air moving apparatus includes a ventilation apparatus mounted on a helmet to be worn on the head of the wearer and configured to be disposed within said airspace defined by said inflated shape of said head cover.

4. The protective garment according to claim 3, wherein said head cover defines an air permeable opening providing an air flow path between said ventilation apparatus and air outside said head cover.

5. The protective garment according to claim 4, wherein said head cover includes a filter disposed within said air permeable opening.

6. The protective garment according to claim 3, wherein:
said ventilation apparatus includes a fan mounted on said helmet and including an air inlet; and
said head cover defines an air permeable opening in communication with said air inlet of said fan.

7. The protective garment according to claim 6, wherein said head cover includes a filter disposed within said air permeable opening.

8. The protective garment according to claim 7 further comprising means for attaching said filter to said fan.

9. The protective garment according to claim 1, wherein:
said head cover defines a neck opening; and
said garment includes means for attaching said head cover to said gown at said neck opening.

10. The protective garment according to claim 9, wherein said means for attaching further provides an air-tight seal.

11. The protective garment according to claim 1, wherein said head cover is formed entirely of said elastic, optically clear material.

12. The protective garment according to claim 1, wherein said head cover is configured to assume a substantially spherical inflated shape.

13. The protective garment according to claim 1, wherein said portion is less than the entirety of said head cover.

14. The protective garment according to claim 13, wherein said portion is disposed at the face of the wearer.

15. The protective garment according to claim 13, wherein the remainder of said head cover other than said portion is formed of a material that is not optically clear.

16. The protective garment according to claim 1, wherein said material is a cellulosic plastic or a silicone resin.

17. The protective garment according to claim 1, wherein said material has a thickness of less than about 0.1 mm.

18. A hood for use as part of a ventilated garment, said hood being defined by a film formed of an elastic material configured to assume an inflated shape about the head of the wearer when pressurized, at least a portion of said material being optically clear.

19. The hood according to claim 18, wherein the entire hood is optically clear.

20. The hood according to claim 18, wherein said portion is less than the entire hood and is disposed at the face of the wearer.

21. The hood according to claim 18, wherein said material is a cellulosic plastic or a silicone resin.

22. The hood according to claim 18, wherein said material has a thickness of less than about 0.1 mm.

23. The hood according to claim 18, wherein:
said material is substantially air impermeable; and
said hood defines an air permeable opening.

24. The hood according to claim 23, further comprising a filter disposed within said air permeable opening.

25. The hood according to claim 18, wherein said inflated shape is substantially spherical.
